(19) United States
(12) Patent Application Publication
(10) Pub. No.: US 2008/0135166 A1
(43) Pub. Date: Jun. 12, 2008

(54) Method for Producing Steering Wheel Decorative Covers and Interior Decorative Elements

(75) Inventors: Norbert Muller, Aschaffenburg (DE); Christian Haart, Obernburg (DE); Martin Sauer, Hosbach (DE)

Correspondence Address: FITCH EVEN TABIN AND FLANNERY, 120 SOUTH LA SALLE STREET, SUITE 1600, CHICAGO, IL, 60603-3406, US

(73) Assignee: TAKATA-PETRI AG, Aschaffenburg (DE)

(21) Appl. No.: 11/766,673

(22) Filed: Jun. 21, 2007

Related U.S. Application Data
(63) Continuation of application No. PCT/DE2005/002302, filed on Dec. 21, 2005.

(30) Foreign Application Priority Data
Dec. 21, 2005 (DE) 10 2004 062 646.4

(51) Int. Cl. B29C 45/14

(52) U.S. Cl. 156/245

(57) ABSTRACT

In one form, the invention relates to steering wheel decorative covers and interior decorative elements, comprising an external visible layer of wood veneer and a plastic support layer. The wood veneer is provided with felt on the inner surface thereof to reduce waste and fashioning work.

### CROSS REFERENCE TO RELATED APPLICATIONS

This is a continuation application of prior application number PCT/DE2005/002302, filed Dec. 21, 2005 and claims the benefit under 35 U.S.C. §119 of prior foreign application number DE 10 2004 062 646.4, filed Dec. 21, 2004.

### FIELD OF THE INVENTION

The invention relates to a method for producing steering wheel decorative covers and interior decorative elements.

### BACKGROUND OF THE INVNETION

Various methods for the production of steering wheel decorative covers and interior decorative elements are known. One method known from practice provides that a decorative layer is applied to a support made of wood, wood material, plastic or metal by means of an adhesive or glue. This method has the disadvantage that a number of operations are required for the production of such an element. Furthermore, if the element is formed in a spherical manner, cracking occurs on the veneers, which can only be deformed to a limited extent.

Furthermore, a curved strip, in particular for the interior of motor vehicles, and a method for its production are known from DE-A 29 44 797 A1. The outer layer of this strip that is visible after installation comprises a wood veneer covering, applied to a supporting layer of plastic. The method for producing this strip is characterized in that a wood veneer covering is placed in an injection mold which is adapted to the later external surface of the strip and said covering is arrested in this position and in that the strip is shaped after being injection-molded with a plastic under high pressure and cooling. This method also has the disadvantage that the wood veneer can crack, and that plastic can be forced through these cracks, but also through pores in the wood veneer. This may result in rejects occurring during production or fashioning work being required.

DE 199 14 092 A1 discloses a cladding and decorative part in which a layer of under-veneer is placed onto a layer of decorative wood veneer and a layer of non-woven impregnated with phenolic melamine resin is arranged in between. The non-woven has the effect of stabilizing and sealing the wood veneer, so that no injection-molding compound can get onto the front side of the veneer in the subsequent injection-molding process. It is also known from this document to preform the wood veneer in a slightly cup- or pot-like manner. However, this slight deformation cannot prevent veneers that are easily damaged by deformation from being damaged, in particular when they are molded as an insert in an injection mold, since this operation is similar to a thermoforming process, in which material undergoes considerable stress.

Furthermore, DE 100 65 550 A1 discloses a method for producing a composite body comprising a support made up of at least one thermoplastic or thermoelastic polymer and at least one decorative layer, in particular a wood veneer, the decorative layer being pressed with the support at elevated pressure and elevated temperature or coated with the polymer as an insert in a mold and at least one film-like layer being arranged between the support and the decorative layer. Pre-forming of the decorative layer is not provided.

### SUMMARY OF THE INVENTION

The invention is based on the object of reducing rejects and fashioning work in the case of steering wheel decorative covers and interior decorative elements.

According to the invention, this is achieved in the way provided by the features described hereinafter.

In the case of a method for producing steering wheel decorative covers and interior decorative elements using a wood veneer or a film, the wood veneer or the film is initially provided on the inside with a non-woven and is subsequently coated with plastic as an insert in an injection mold, the wood veneer provided with the non-woven being brought into a form desired for the intended purpose before the insert molding process.

The non-woven layer is therefore laminated onto the wood veneer, for example by adhesion, before it is introduced into the injection mold. The wood veneer is subsequently introduced into the injection mold. The wood veneer provided with the non-woven is deformed, i.e. brought into a form desired for the intended purpose, before the insert molding process. This procedure allows veneers that are easily damaged by deforming to be used. Such damage may occur in particular when they are coated as an insert in an injection mold, since this operation is similar to a thermoforming process, in which the material undergoes considerable stress. If the wood veneer provided with the non-woven is already deformed before the insert molding process, a deforming method in which the risk of the veneer being damaged is low may be chosen.

It is necessary to choose an adhesive known per se of such a kind that ensures that the bonding remains stable after the insert molding or is not broken down by the insert molding.

It is expedient to provide the non-woven as a layer with a thickness of at least 0.1 mm and at most 2.0 mm. It is also expedient that the wood veneer has a thickness of less than 0.6 mm.

It is also expedient that fastening and mounting aids, such as hooks, tenons, tongues, grooves, spikes, centering aids and energy directing elements are integrally formed on the plastic support layer and that the plastic support layer consists of a thermoplastic or a melt-processable natural material.

It is expedient that the wood veneer is ground before the deforming. The grinding may be performed before or after the laminating with non-woven. This minimizes the effort involved in grinding the finished part, which usually has to be carried out manually because of the often complex form. Furthermore, the wood veneer may be flexed, i.e. made flexible, before introduction into the injection mold, in order to make it more easily deformable. In this case, the wood fibers of the veneer are broken by rolling.

### BRIEF DESCRIPTION OF THE DRAWINGS

The invention is to be explained in an exemplary embodiment on the basis of drawings, in which:

FIG. 1 shows a longitudinal section through a wood decorative cover

FIG. 2 shows a cross section through the wood decorative cover as shown in FIG. 1.

### DETAILED DESCRIPTION OF THE DRAWINGS

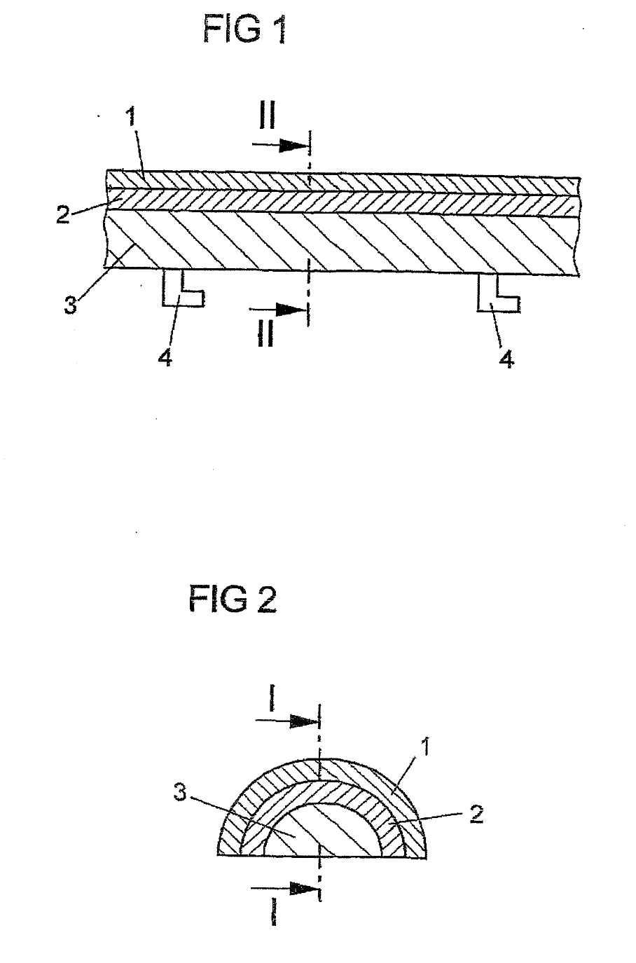

As can be seen from FIG. 1, the wood decorative cover comprises a wood veneer 1, which has been provided with a non-woven layer 2. These two layers have been provided with a plastic support layer 3 in an injection mold. It can be seen from FIG. 2 that the wood veneer 1 is greatly curved. With this great curvature, there is the risk of the veneer cracking. However, the wood veneer is stabilized by the non-woven layer 2 in such a way that it can be curved to the extent represented in FIG. 2 without any cracks. Fastening aids, such as the hooks 4 represented, are integrally formed on the plastic support layer 3.

What is claimed is:

1. A method for producing steering wheel decorative covers and interior decorative elements using a wood veneer or a film, characterized in that the wood veneer or the film is initially provided on the inside with a non-woven and is subsequently coated with plastic as an insert in an injection mold, the wood veneer provided with the non-woven being brought into a form desired for the intended purpose before the insert molding process.

2. The method as claimed in claim 1, characterized in that the wood veneer is ground before being introduced into the injection mold.

3. The method as claimed in claim 1, characterized in that the wood veneer is flexed.

4. The method as claimed in claim 1, characterized in that the non-woven is provided as a layer with a thickness of at least 0.1 mm and at most 2.0 mm.

5. The method as claimed in claim 1, characterized in that the wood veneer has a thickness of less than 0.6 mm.

6. The method as claimed in claim 1, characterized in that fastening and mounting aids are integrally formed on the plastic support layer.

7. The method as claimed in claim 6, characterized in that hooks, tenons, tongues, grooves, spikes, centering aids and energy directing elements are integrally formed.

8. The method as claimed in claim 1, characterized in that the plastic support layer consists of a thermoplastic.

9. The method as claimed in claim 1, characterized in that the plastic support layer consists of a melt-processable natural material.
